(19) United States
(12) Patent Application Publication
(10) Pub. No.: US 2025/0053858 A1
(43) Pub. Date: Feb. 13, 2025

(54) POST-MODELING VISUALIZATION

(71) Applicant: International Business Machines Corporation, Armonk, NY (US)

(72) Inventors: Si Er Han, Xi'an (CN); Xiao Ming Ma, Xi'an (CN); Wen Pei Yu, Xi'an (CN); Xue Ying Zhang, Xi'an (CN); Jing Xu, Xi'an (CN); Jing James Xu, Xi'an (CN); Jun Wang, Xi'an (CN); Lei Tian, Xi'an (CN)

(21) Appl. No.: 18/446,149

(22) Filed: Aug. 8, 2023

(51) Int. Cl. G06N 20/00

(52) U.S. Cl. CPC G06N 20/00

(57) ABSTRACT

In an approach, a processor selects a top N features for a machine learning (ML) model; discretizes values of each continuous feature of the top N features; generates a set of combination values that each represent a unique combination of feature values in for a data record; predicts, using the ML model, a target value for each record generating predicted target values; groups the predicted target values based on the combination value for each respective record; fits a distribution for each grouping of the predicted target values associated with a respective combination value generating a set of distributions; clusters and refits the set of distributions using a clustering algorithm resulting in a set of clusters and a refitted distribution for each cluster of the set of clusters; and outputs a visualization of the refitted distribution for each cluster as a distribution curve on a graph along with the associated records.

### BACKGROUND OF THE INVENTION

The present invention relates generally to the field of data visualization, and more particularly to an approach for post-modeling visualization and analysis.

Data visualization is a representation of data using common graphics, such as tables, pie charts, stacked bar charts, line charts, area charts, histograms, scatter plots, heat maps, tree maps, infographics, and animations. These visual displays of information communicate complex data relationships and data-driven insights in a way that is easy to understand. Data visualization can be utilized for a variety of purposes. For example, while text mining, data analysts and data scientists may use a word cloud to capture key concepts, trends, and hidden relationships within unstructured data. Alternatively, data analysts and data scientists may utilize a graph structure to illustrate relationships between entities of the data.

Post-modeling visualization and analysis plays an important role in helping users understand modeled data and in directing actions in a next stage. Feature importance, model accuracy, confusion matrix, receiver operating characteristic (ROC) curve, etc. can each give an overall evaluation for a model on the entire data.

### SUMMARY

Aspects of an embodiment of the present invention disclose a method, computer program product, and computer system for post-modeling data visualization and analysis. A processor selects a top N features for a machine learning (ML) model trained on training data. A processor discretizes values of each continuous feature of the top N features into a set of categories. A processor generates a set of combination values that each represent a unique combination of feature values in a row representing a record within the training data. A processor predicts, using the ML model, a target value for each record within the training data generating predicted target values. A processor groups the predicted target values based on the combination value for each respective record of the training data. A processor fits a distribution for each grouping of the predicted target values associated with a respective combination value generating a set of distributions and associated distribution curves. A processor clusters and refits the set of distributions using a clustering algorithm to compress a number of distributions resulting in a set of clusters and a refitted distribution for each cluster of the set of clusters, wherein each refitted distribution is based on records associated with each distribution of the associated cluster. A processor assigns a different color to each feature of the top N features and a different shade of the respective different color for each category of the set of categories for the respective feature. A processor output a visualization of (1) the refitted distribution for each cluster as a distribution curve on a graph and (2) the associated records of the top N features as a table.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a computing environment, for running a post-modeling visualization program, in accordance with an embodiment of the present invention.

FIG. 2 is a flowchart depicting operational steps of the post-modeling visualization program, for post-modeling visualization of a machine learning model built on training data, running on a computer of the distributed data processing environment of FIG. 1, in accordance with an embodiment of the present invention.

FIG. 3A shows an example of a step of post-modeling visualization program for discretizing continuous features into categories, in accordance with an embodiment of the present invention.

FIG. 3B shows an example of a step of post-modeling visualization program for generating a set of combination values based on the discretized continuous features, in accordance with an embodiment of the present invention.

FIG. 3C shows an example of a step of post-modeling visualization program for outputting the visualization of the clustered records of top N important features with associated distribution plot for each cluster, in accordance with an embodiment of the present invention.

FIG. 3D shows an example of a step of post-modeling visualization program for highlighting a set of records associated with portion of data in an associated distribution plot that was selected by a user, in accordance with an embodiment of the present invention.

### DETAILED DESCRIPTION

Embodiments of the present invention recognize that, in addition to the graphical representation of modeled data, numerical factors, such as feature importance, model accuracy, confusion matrix, and ROC curves, can be provided for an overall evaluation of the modeled data. However, when a user wants to know more detailed information, such as the model's effect or insight on a specific portion of data, these statistical features do not provide the desired information. Therefore, embodiments of the present invention recognize the need for post-modeling visualization that shows the model's effect/evaluation on various parts of the data and data structure/pattern.

Embodiments of the present invention provide a system and method for post-modeling visualization by selecting a top N important features, discretizing continuous features of the top N important features into categories, splitting the data into blocks by combining categorical value of each feature, and fitting the distribution of predictions (or residuals) by the model for each block. Embodiments of the present invention further provide a system and method for post-modeling visualization by clustering based on distribution statistics, merging records belonging to one cluster, and refitting the distribution of predictions with merged data from the merging of records. Embodiments of the present invention further provide a system and method for post-modeling visualization by encoding the categories of each feature into colors and visualizing the top N important features and predictions using a heat map-like chart.

Embodiments of the present invention provide several advantages over conventional methods including (1) enabling visualization of an input feature and its prediction evaluation effect on a certain block of data; (2) giving a detailed picture of post-modeling evaluations and insights; and (3) providing a method for visualizing multi-dimensional data (i.e., multiple features of the data).

Implementation of embodiments of the present invention may take a variety of forms, and exemplary implementation details are discussed subsequently with reference to the Figures.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

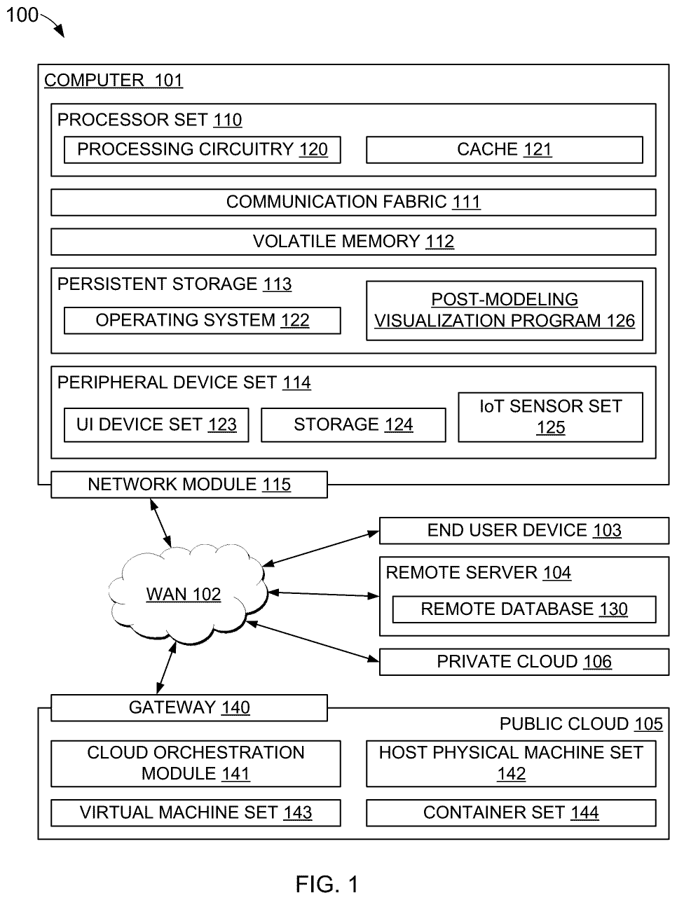

In FIG. 1, computing environment 100 contains an example of an environment for the execution of at least some of the computer code involved in performing the inventive methods, such as post-modeling visualization program 126. In addition to block 126, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 126, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processors set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 116 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

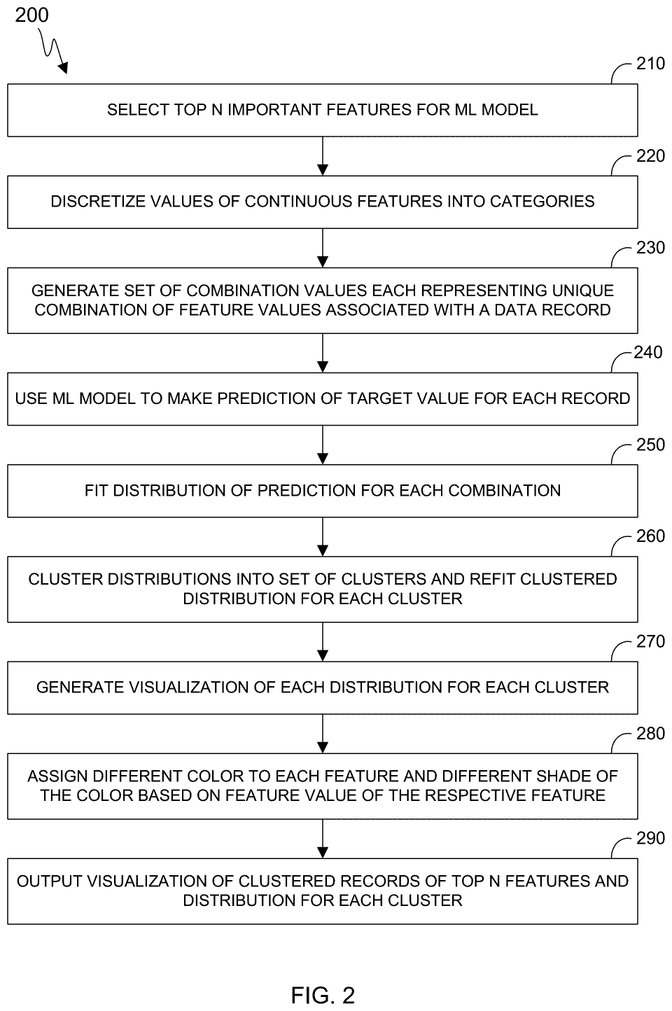

FIG. 2 is a flowchart, generally designated 200, illustrating the operational steps for post-modeling visualization program 126, running on computer 101 of computing environment 100 of FIG. 1, in accordance with an embodiment of the present invention. In an embodiment, post-modeling visualization program 126 operates to provide visualizations of a ML model trained on a set of training data. It should be appreciated that the process depicted in FIG. 2 illustrates one possible iteration of the process flow, which may be repeated as machine learning models are built and trained on a set of training data.

In step 210, post-modeling visualization program 126 selects a top number (N) of important features for a machine learning (ML) model, in which N is an integer larger than zero (0) and less than a total number of features in the ML model. In an embodiment, post-modeling visualization program 126 identifies the top N important features based on modeling information of the ML model, i.e., determining feature importance for each feature using modeling information, as known to a person of skill in the art. In an embodiment, post-modeling visualization program 126 computes feature importance for each feature by checking the changes in accuracy of the model when the respective feature values are changed, i.e., the larger the changes in accuracy of the model, the more important the feature is. Each record within the set of training data has a value associated with each feature of the training data. In an embodiment, post-modeling visualization program 126 identifies the top N important features by determining the features that contribute to a pre-set threshold percentage of the accuracy of the ML model, e.g., more than or equal to 75% of the accuracy. In an embodiment, post-modeling visualization program 126 determines the top N important features needed to reach the pre-set threshold percentage of accuracy of the ML model by starting with the feature with the highest feature importance (e.g., F1) and if the accuracy is more than the pre-set threshold percentage, then just that feature F1 is identified as the top N important feature with N=1. If the accuracy is lower than the pre-set threshold percentage, then the second important feature (e.g., F2) is added and used to compute the accuracy of the model. If the accuracy of F1+F2 is more than the pre-set threshold percentage, then F1 and F2 are used as the top N important features with N=2. If the accuracy of F1+F2 is lower than the pre-set threshold percentage, then the next important feature (e.g., F3) is added to the accuracy calculation, and this determination is repeated until the pre-set threshold percentage of accuracy is reached.

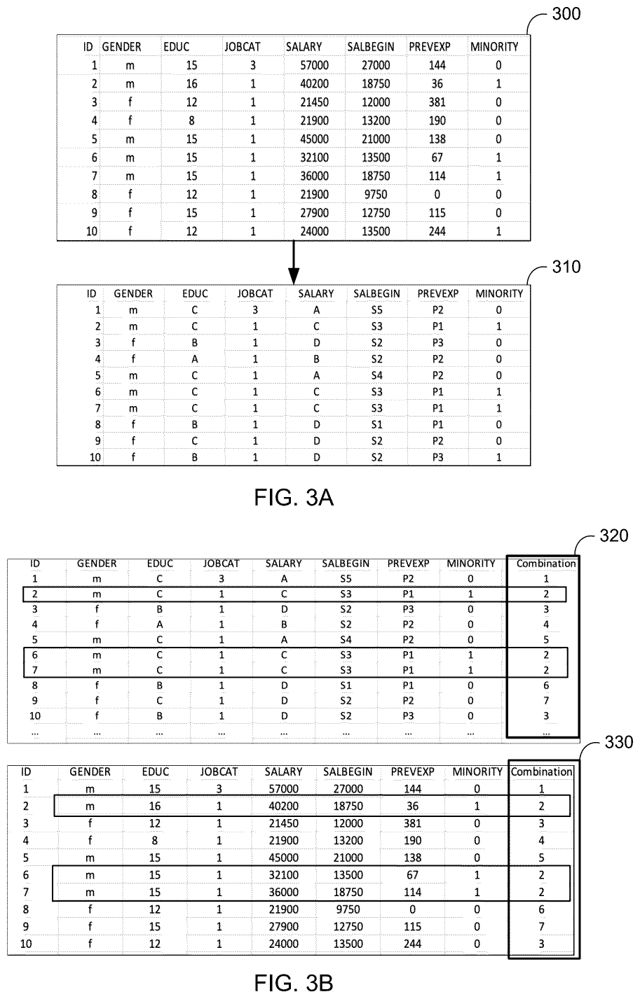

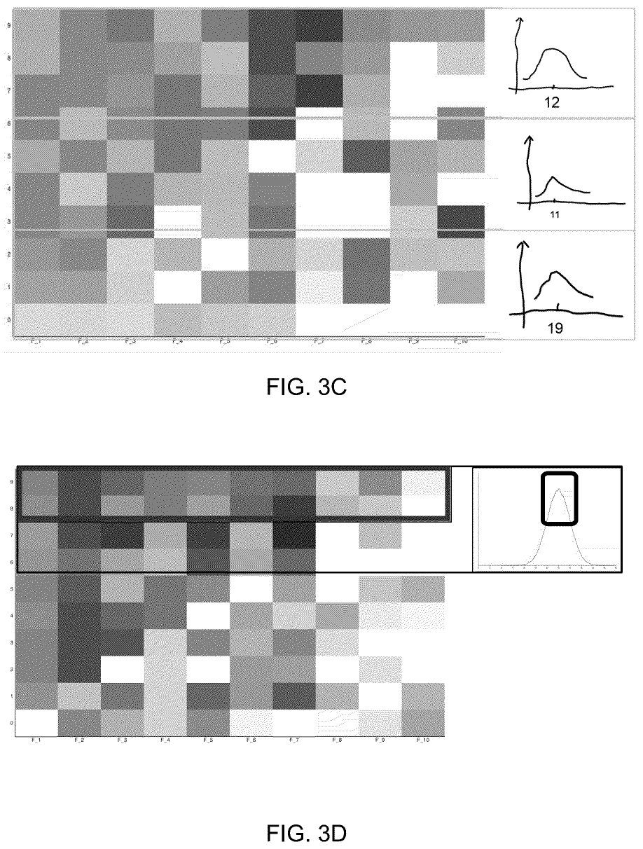

In step 220, post-modeling visualization program 126 discretizes values of each continuous feature into categories. A continuous feature is defined as type of feature that can have any numerical value within a specific range, e.g., salary. In an embodiment, post-modeling visualization program 126 discretizes values of each continuous feature of the top N important features into categorical values by applying equal frequency binning methodology (as known to a person of skill in the art) making a frequency of each categorical value equal. In an embodiment, for each continuous feature, post-modeling visualization program 126 replaces each original feature value with an associated categorical value for each record in the training data. For example, if a feature has twenty (20) data points, the 20 data values can be discretized into five (5) bins by sorting the data points in ascending order and then grouping each set of four data points into a bin. FIG. 3A shows an example of step 220 for discretizing values of each continuous feature into categories with chart 300 depicting the features and values for a set of records of a set of training data before the discretizing step and chart 310 depicting the features and values for the set of records after the discretizing step. In FIG. 3A, post-modeling visualization program 126 discretizes the features of “EDUC”, “SALARY”, “SALBEGIN”, and “PREVEXP” into categories, such as for the “EDUC” feature the values of 8, 12, 15, and 16 are discretized into the categories of A, B, and C.

In step 230, post-modeling visualization program 126 generates a set of combination values that each represent a unique combination of feature values associated with a record of data (or data record). In an embodiment, post-modeling visualization program 126 generates a set of combination values (e.g., 1, 2, . . . n, in which n represents the number of unique combinations) that each represent a unique combination of feature values (categorical values for continuous features) associated with one record (i.e., row of data). In an embodiment, post-modeling visualization program 126 adds a combination column to the original data (i.e., original training data of the ML model and not the data with discretized/categorical values from the previous step) with the combination values for each record. It is possible for multiple records to have the same combination value, i.e., have the same unique combination of feature values. FIG. 3B shows an example of step 230 for generating a set of combination values each of which is associated with a unique combination of feature values for a record of data. In FIG. 3B, record 1 has the unique combination of feature values of m, C, 3, A, S5, P2, and 0, thus post-modeling visualization program 126 labels this record as combination 1. In FIG. 3B, records 2, 6, and 7 each have the same unique combination of features values of m, C, 1, C, S3, P1, and 1, thus post-modeling visualization program 126 labels these as combination 2.

In step 240, for each combination value and each record associated with the respective combination value, post-modeling visualization program 126 uses the ML model to predict a target value for each of the associated records for the respective combination value and receives a prediction for the target value. In machine learning, the training data is usually a table with a column for target value to be predicted, columns for each feature, and rows for each record. In an embodiment, post-modeling visualization program 126 uses the ML model to determine a prediction of the target value of a record using the values of the features of that record generating predicted target values. In an embodiment, post-modeling visualization program 126 groups the predicted target values based on the combination value for each respective record of the training data. In some embodiments, post-modeling visualization program 126 calculates a residual for each record using the prediction of the target value output by the ML model. The residual for a record, which can be used to evaluate the model. can be calculated as y−y_p, where y is the actual target value and y_p is the prediction of the target value.

In step 250, post-modeling visualization program 126 fits a distribution of the predictions for each combination. This results in a number of distributions equal to the number of unique combinations determined in step 230. In an embodiment, post-modeling visualization program 126 fits a statistical distribution of the predictions or residuals for each combination value, e.g., the prediction values or residual values for each record with combination value of 2, as can be seen in FIG. 3B at rows 2, 6, and 7. The predictions or residuals for combination 2 follow a statistical distribution, such as a normal distribution with parameters “mean” and “variance”. In an embodiment, post-modeling visualization program 126 computes the “mean” and “variance” parameters using the prediction values or residual values to fit the distribution for that particular combination. In an embodiment, post-modeling visualization program 126 generates a graph of the distribution for each combination with the prediction values or residual values along the x axis and the density function values of distribution used along the y-axis.

In step 260, post-modeling visualization program 126 clusters the distributions and refits the clustered distributions. In an embodiment, post-modeling visualization program 126 clusters the distributions into a set of clusters using the mean and variance parameters for each distribution as input features to a clustering algorithm, e.g., K-means clustering, to compress the number of distributions. In an embodiment, post-modeling visualization program 126 groups records belonging to distributions of one cluster of the set of clusters into a block of records. In an embodiment, for each cluster, post-modeling visualization program 126 refits a distribution for a respective cluster using the associated block of records.

In step 270, post-modeling visualization program 126 generates a visualization of each distribution for each cluster. In an embodiment, post-modeling visualization program 126 generates a visualization of each distribution as a two-dimensional graph, and more specifically a statistic distribution curve with the x-axis being the prediction value or residual value and the y-axis being the density function curve if the prediction is used.

In step 280, post-modeling visualization program 126 assigns a different color to each feature and a different shade of the color for different ranges of feature values or for each categorical value of the respective feature. For example, if the categorical values for feature A range from 1 to 10 and the color blue was assigned to feature A, then a different shade of blue is assigned to each of the 10 categories, and preferably the shades range from darkest to lightest or lightest to darkest correspondingly with the range of categorical values.

In step 290, post-modeling visualization program 126 outputs the visualization of the grouped records of the top N important features, as a heat map-like chart, i.e., similar to a heat-map, along with the respective (refitted) distribution for each cluster. FIG. 3C shows an example of step 290 for outputting the visualization of a table of the clustered records of top N important features visually associated with associated distribution plot graph for each cluster. Conventionally. ML models are evaluated on an entire data set that gives a single quality measure. However, the ML model may be good for some of records and bad for the other records, which cannot be discerned by using a single evaluation metric on the entire data set. By creating this visualization, the quality of the ML model can be easily visualized for different data blocks partitioned by distributions of predictions or residuals. An advantage of this visualization is to help a user understand what kind of data the ML model can predict accurately and what kind of data the model can predict inaccurately.

In some embodiments, in response to a user selecting a portion of the data in a distribution plot, post-modeling visualization program 126 highlights corresponding records. FIG. 3D shows an example of step 290 for highlighting a set of records associated with portion of data in associated distribution plot that was selected by a user. In other words, if a user is interested in the prediction in a specific range of data (as easily determined by the color shading of the data), the user can select the associated part in the distribution curve, and then the corresponding block of records will be highlighted for the user.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
selecting, by one or more processors, a top N features for a machine learning (ML) model trained on training data;
discretizing, by the one or more processors, values of each continuous feature of the top N features into a set of categories;
generating, by the one or more processors, a set of combination values that each represent a unique combination of feature values in a row representing a record within the training data;
predicting, by the one or more processors, using the ML model, a target value for each record within the training data generating predicted target values;
grouping, by the one or more processors, the predicted target values based on the combination value for each respective record of the training data;
fitting, by the one or more processors, a distribution for each grouping of the predicted target values associated with a respective combination value generating a set of distributions and associated distribution curves;
clustering and refitting, by the one or more processors, the set of distributions using a clustering algorithm to compress a number of distributions resulting in a set of clusters and a refitted distribution for each cluster of the set of clusters, wherein each refitted distribution is based on records associated with each distribution of the associated cluster;
assigning, by the one or more processors, a different color to each feature of the top N features and a different shade of the respective different color for each category of the set of categories for a respective feature of the top N features; and
outputting, by the one or more processors, a visualization of (1) the refitted distribution for each cluster as a distribution curve on a graph and (2) the associated records of the top N features as a table.

2. The computer-implemented method of claim 1, wherein selecting the top N features for the ML model comprises:
computing, by the one or more processors, a feature importance for each feature of the ML model based on an association between changes in feature values and changes in an accuracy of the ML model; and
determining, by the one or more processors, the top N features that contribute to a pre-set threshold accuracy percentage for the ML model based on the feature importance for each feature.

3. The computer-implemented method of claim 1, wherein discretizing values of each continuous feature comprises:
applying, by the one or more processors, equal frequency binning to a set of values for a continuous feature generating a set of categorical values for the continuous feature.

4. The computer-implemented method of claim 1, further comprising:
adding, by the one or more processors, a new column to the training data with respective combination values for each record.

5. The computer-implemented method of claim 1, further comprising:
responsive to a user selecting a portion of data on one of the distribution curves, highlighting, by the one or more processors, corresponding records associated with the portion of data.

6. The computer-implemented method of claim 1, further comprising:
calculating, by the one or more processors, a residual value for each record based on the corresponding predicted target value and an actual target value.

7. The computer-implemented method of claim 1, wherein fitting the distribution comprises:
computing, by the one or more processors, a mean and a variance of the predicted target values for each combination value.

8. A computer program product comprising:
one or more computer readable storage media and program instructions stored on the one or more computer readable storage media, the program instructions comprising:
program instructions to select a top N features for a machine learning (ML) model trained on training data;
program instructions to discretize values of each continuous feature of the top N features into a set of categories;
program instructions to generate a set of combination values that each represent a unique combination of feature values in a row representing a record within the training data;
program instructions to predict, using the ML model, a target value for each record within the training data generating predicted target values;
program instructions to group the predicted target values based on the combination value for each respective record of the training data;
program instructions to fit a distribution for each grouping of the predicted target values associated with a respective combination value generating a set of distributions and associated distribution curves;
program instructions to cluster and refit the set of distributions using a clustering algorithm to compress a number of distributions resulting in a set of clusters and a refitted distribution for each cluster of the set of clusters, wherein each refitted distribution is based on records associated with each distribution of the associated cluster;
program instructions to assign a different color to each feature of the top N features and a different shade of the respective different color for each category of the set of categories for each respective feature; and
program instructions to output a visualization of (1) the refitted distribution for each cluster as a distribution curve on a graph and (2) the associated records of the top N features as a table.

9. The computer program product of claim 8, wherein the program instructions to select the top N features for the ML model comprise:
program instructions to compute a feature importance for each feature of the ML model based on an association between changes in feature values and changes in an accuracy of the ML model; and
program instructions to determine the top N features that contribute to a pre-set threshold accuracy percentage for the ML model based on the feature importance for each feature.

10. The computer program product of claim 8, wherein the program instructions to discretize values of each continuous feature comprise:
program instructions to apply equal frequency binning to a set of values for a continuous feature generating a set of categorical values for the continuous feature.

11. The computer program product of claim 8, further comprising:
program instructions to add a new column to the training data with respective combination values for each record.

12. The computer program product of claim 8, further comprising:
responsive to a user selecting a portion of data on one of the distribution curves, program instructions to highlight corresponding records associated with the portion of data.

13. The computer program product of claim 8, further comprising:
program instructions to calculate a residual value for each record based on the corresponding predicted target value and an actual target value.

14. The computer program product of claim 8, wherein the program instructions to fit the distribution comprise:
program instructions to compute a mean and a variance of the predicted target values for each combination value.

15. A computer system comprising:
one or more computer processors;
one or more computer readable storage media;
program instructions collectively stored on the one or more computer readable storage media for execution by at least one of the one or more computer processors, the stored program instructions comprising:
program instructions to select a top N features for a machine learning (ML) model trained on training data;
program instructions to discretize values of each continuous feature of the top N features into a set of categories;
program instructions to generate a set of combination values that each represent a unique combination of feature values in a row representing a record within the training data;
program instructions to predict, using the ML model, a target value for each record within the training data generating predicted target values;
program instructions to group the predicted target values based on the combination value for each respective record of the training data;
program instructions to fit a distribution for each grouping of the predicted target values associated with a respective combination value generating a set of distributions and associated distribution curves;
program instructions to cluster and refit the set of distributions using a clustering algorithm to compress a number of distributions resulting in a set of clusters and a refitted distribution for each cluster of the set of clusters, wherein each refitted distribution is based on records associated with each distribution of the associated cluster;
program instructions to assign a different color to each feature of the top N features and a different shade of the respective different color for each category of the set of categories for each respective feature; and
program instructions to output a visualization of (1) the refitted distribution for each cluster as a distribution curve on a graph and (2) the associated records of the top N features as a table.

16. The computer system of claim 15, wherein the program instructions to select the top N features for the ML model comprise:
program instructions to compute a feature importance for each feature of the ML model based on an association between changes in feature values and changes in an accuracy of the ML model; and
program instructions to determine the top N features that contribute to a pre-set threshold accuracy percentage for the ML model based on the feature importance for each feature.

17. The computer system of claim 15, wherein the program instructions to discretize values of each continuous feature comprise:
program instructions to apply equal frequency binning to a set of values for a continuous feature generating a set of categorical values for the continuous feature.

18. The computer system of claim 15, further comprising:
program instructions to add a new column to the training data with respective combination values for each record.

19. The computer system of claim 15, further comprising:
responsive to a user selecting a portion of data on one of the distribution curves, program instructions to highlight corresponding records associated with the portion of data.

20. The computer system of claim 15, further comprising:
program instructions to calculate a residual value for each record based on the corresponding predicted target value and an actual target value.
